(19) United States
(12) Patent Application Publication
(10) Pub. No.: US 2006/0056372 A1
(43) Pub. Date: Mar. 16, 2006

(54) Method and apparatus for using multiple data-stream pathways

(75) Inventors: Jeyhan Karaoguz, Irvine, CA (US); James Bennett, San Clemente, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 10/937,320

(22) Filed: Sep. 10, 2004

(51) Int. Cl. H04H 1/00; H04Q 7/00

(52) U.S. Cl. 370/339; 370/329

(57) ABSTRACT

A method for using multiple independent data pathways to accomplish a task is disclosed. The method includes determining availability of multiple independent data pathways, where at least one of the data pathways utilizes transmission and receipt of data through an over-the-air antenna, selecting at least two of the data pathways, based on certain criteria and sending and receiving data along the selected at least two data pathways to accomplish a task.

### BACKGROUND OF THE INVENTION

1. Field of Invention

The present invention relates to broadband access to data through multiple mechanisms in a home or business. In particular, the present invention is directed to hardware and software that are configured to use multiple data-stream pathways based on bandwidth and/or other criteria.

2. Description of Related Art

The availability of the distribution of programming in the United States and abroad via satellite is ubiquitous. Consumers position a satellite dish, or have the same installed, to communicate with satellites that are in geosynchronous orbit and are able to send and/or receive data. Different types of satellite dishes can be used, based on the provider of satellite data, as well as on the number of satellites that are to be received by the satellite dish antenna. Currently, such data has an approximate downstream, i.e. from the satellite to the satellite receiver connected to the satellite dish, throughput of about 40 megabit per second. This allows for the receiver to readily receive data, such as television schedule data, as well as video and other programming, and to display that data to the end user. There are at present many different types of satellite services providing satellite television programming, as well services providing Internet access through satellite communication.

However, the upstream, i.e. from the receiver to the satellite, speeds are much less. The upstream path, through, for example, the Ka-band, provides only for low bandwidth at rates of approximately 3 MHz. The disjoint upstream and downstream paths are understandable because of the number of users of the service. In other words, there are many end users seeking to receive the same data, i.e. television programming, and the need to send data upstream at a rate similar to the downstream rate is not present. Thus, while the difference in the upstream and downstream rates poses no real problem for satellite television, the difference becomes a distinct disadvantage if a user sought to use the satellite infrastructure to send and receive data at parity rates.

Thus, there exist many satellite television users that have the capacity to receive high speed data, i.e. their satellite systems, but must utilize other means to provide Internet access or send data upstream. Such access could be through dialup connections or through Digital Subscriber Line (DSL) or cable modems. All of those options require additional wiring or limit the access rate. In satellite based Internet access, the above-discussed disparity in upstream and downstream rates usually requires for a user having such satellite based Internet access to have an additional upstream path, such as through DSL or cable modems. This creates a dichotomy for the end user in that the user must have dealings with both satellite service providers and cable service providers, where the providers distribute overlapping services.

Additionally, other types of high speed data access are also being developed. One such technology is covered through various incarnations of Institute of Electrical and Electronics Engineers (IEEE) 802.16 standard. Such access is often referred to as broadband access, Wimax or fixed broadband wireless. IEEE 802.16 is a specification for fixed broadband wireless networks that use a point-to-multipoint architecture. The standard defines the use of bandwidth between the licensed 10 GHz and 66 GHz and between the 2 GHZ and 11 GHz (licensed and unlicensed) frequency ranges and defines a Media Access Control (MAC) layer that supports multiple physical layer specifications customized for the frequency band of use and their associated regulations. 802.16, depending on the embodiment, supports data rates of between 32-134 Mbps at 28 MHz channels, up to 75 Mbps at 20 MHz channels or up to 15 Mbps at 5 MHz channels. 802.16 supports these very high bit rates in both uploading to and downloading from a base station up to a distance of 30 miles to handle such services as Internet Protocol (IP) connectivity, Voice over IP, and Time Division Multiplexing (TDM) voice and data.

However, for most incarnations of wireless broadband access, there is need for an additional antenna to receive the signal. Additionally, in some types of broadband access, there is a need for a line-of-sight between the source and the receiving antenna, often requiring that the antenna for broadband access to external to a home or office and requiring that the antenna to be directionally configurable to receive the signal. However, if an end user has multiple types of data access, such as received from satellite and broadband access antennas, those access methods remain separate, such that the end user could have the ability to receive vast amounts of data, but bandwidth is spread over many devices that do not communicate or cooperate with each other. Thus, there is a need in the prior art for systems that can utilize multiple data-stream pathways based on bandwidth and/or other criteria.

### SUMMARY OF THE INVENTION

According to one embodiment of the invention, a method for using multiple independent data pathways to accomplish a task is disclosed. The method includes determining availability of multiple independent data pathways, where at least one of the data pathways utilizes transmission and receipt of data through an over-the-air antenna, selecting at least two of the data pathways, based on certain criteria and sending and receiving data along the selected at least two data pathways to accomplish a task.

Additionally, the method may include initializing the multiple independent data pathways and saving information about the data pathways and their characteristics in an accessible list. Also, a software application may supply the certain criteria or task requests from the electronic device may have predetermined certain criteria. In addition, the at least one of the data pathways may utilize a satellite antenna or a broadband access antenna.

In addition, the certain criteria may be selected based on a type of data to be sent and received or based on bandwidths of each of the data pathways. Also, the step of sending and receiving data along the selected at least two data pathways to accomplish a task may include sending and receiving data along the selected at least two data pathways to provide interactive television services along with satellite television programming. In addition, the data received from the selected at least two data pathways may be combined, such that combined data appears to an application to have been derived along a single data pathway.

According to another embodiment, a component using multiple independent data pathways to accomplish a task is disclosed. The component includes determining means for determining availability of multiple independent data pathways, where at least one of the data pathways utilizes transmission and receipt of data through an over-the-air antenna, selecting means for selecting at least two of the data pathways, based on certain criteria and tasking means for sending and receiving data along the selected at least two data pathways to accomplish a task.

According to another embodiment, a set top box is disclosed. The set top box includes at least one port, configured to send data to and receive data from multiple independent data pathways, where at least one of the data pathways utilizes transmission and receipt of signals through an over-the-air antenna and a processing module, configured to determine availability the data paths, select at least two of the data pathways, based on certain criteria and monitor a task utilizing the selected at least two data pathways.

These and other variations of the present invention will be described in or be apparent from the following description of the preferred embodiments.

### BRIEF DESCRIPTION OF THE DRAWINGS

For the present invention to be easily understood and readily practiced, the present invention will now be described, for purposes of illustration and not limitation, in conjunction with the following figures:

FIG. 1 provides an illustration of a combined satellite antenna and broadband access antenna and associated circuitry and wiring, according to one embodiment of the present invention;

FIG. 2 illustrates a downconverter for converting signals received from the antennas and supplying them internally to the home or office, according to one embodiment of the present invention;

FIG. 3 illustrates a schematic of a set top box or other component, according to one embodiment of the present invention; and

FIG. 4 provides a flow chart of a process of using multiple data pathways, according to one embodiment of the present invention.

### DETAILED DESCRIPTION OF PREFERRED EMBODIMENTS

The invention is directed, according to at least one embodiment, to the use of multiple data-stream pathways, where broadband access and satellite signals are received jointly. The invention, according to some embodiments, allows for the use of the multiple pathways to alleviate congestion along any one of those pathways. Thus, if one of the data-streams has insufficient bandwidth, other streams may be used to provide the end user or product with all of the data. For example, if program data is being sent over the satellite signal data-stream, that delivery can be supplemented through the transmission and receipt of some or all of that data through the broadband access transmission. The use of multiple pathways can be made on a contingent basis, based upon availability, bandwidth and pathway type. Thus, a video program may be received through multiple pathways to utilize the total bandwidths of all of the pathways.

The selection of data-streams also allows for multiple devices to select their own means of communication, according to another embodiment of the present invention. One example of this utilization of multiple paths may be through wireless local area networks, where elements off the network could choose a particular path or a set of paths to facilitate the flow of data. Thus, if a broadband access point, such as a cable modem, is reduced in capacity or is unavailable, the wireless local area network could automatically utilize the bandwidth of a WiMax antenna on the roof. In another example, a camera that communicates through a protocol such as BLUETOOTH, a short-range radio technology, may choose a pathway that allows for the data sent via BLUETOOTH to be transmitted through an antenna, such as a Wimax antenna, on the roof and serviced through a distant entity. This self selection may be accomplished through communication between the device and the entity providing the bridging between the pathways.

The invention, according to at least one embodiment, also allows for multiple pathways to be combined, such that multiple data-streams are stitched together such that the process is invisible to the end user or product. The multiple pathways also allow for multiple uses to be made of the pathways that are separate. Thus, the invention may allow for greater interactive services to be provided to satellite television, where the upstream communication with the satellite is limited in bandwidth and interactive services may be provided through broadband access and other broadband communication streams.

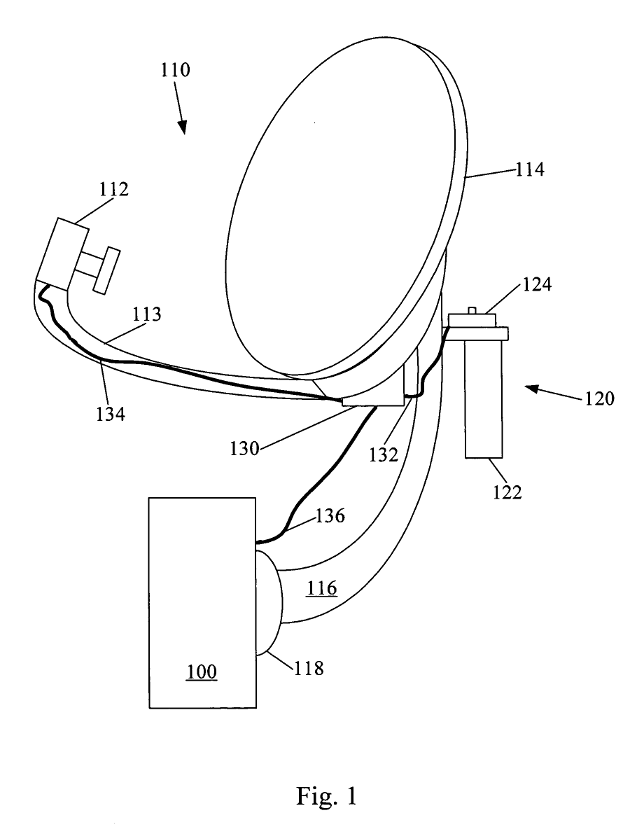

A combined satellite antenna and broadband access antenna, according to one embodiment, is illustrated in FIG. 1. The appearance of the elements is for illustrative purposes only, and is not intended to be limiting. Satellite antenna 110 has a dish or collimating section 114 and at least one low noise converter (LNC) 112, supported by arm 113, where the LNC is focused at one of the foci of the dish. LNC 112 acts to convert a received signal to the 950-2150 MHz range and amplified that signal. The amplified signal is sent, along cabling 134, to a downconverter 130. The downconverter does a further conversion of the signal and sends the signal to at least the building along cable 136.

The satellite antenna 110 is supported to an attachment support 116, which affixes the satellite antenna to a support 100. The support 100 can be a portion of a building housing the satellite receiver or may be a pole if the satellite antenna needs to be so mounted to receive a signal from the proper satellite. The attachment support 116 is connected to the support 100 through an adjustable connector 118. the adjustable connector allows for partial positioning of the satellite antenna to receive signals from the satellite. Additional adjustment mechanisms, not illustrated, are provided closer to the dish portion 114 to allow for positioning over additional degrees of freedom.

Also illustrated in the combined antenna assembly is a broadband access antenna 120. According to certain embodiments of the invention, the broadband access antenna is affixed to the support sections of the satellite antenna 110. Alternatively, the broadband access antenna could be mounted next to but not attached to the satellite antenna. Additionally, while FIG. 1 illustrates the broadband access antenna being attached to a section of the attachment support 116, the broadband access antenna can be attached to any stable portion of the satellite antenna. The broadband access antenna 120 includes a transmission and receive section 122 and an adjustment mechanism 124. The adjustment mechanism allows for the transmission and receive section to be aimed at the source of the broadband access transmitter. The signal received through the broadband access antenna is carried to the downconverter 130 through a cable 132.

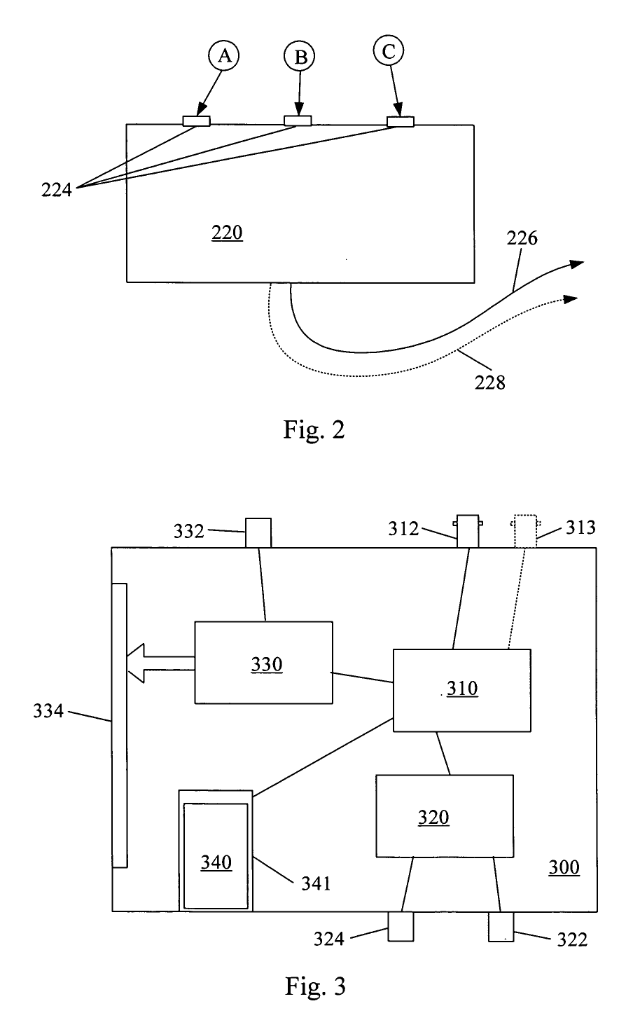

FIG. 2 illustrates a simplified schematic of a downconverter 220, according to an embodiment of the present invention. The downconverter has multiple input ports 224 for receiving signals from several antenna sources. The downconverter allows the received signals to be shifted to another frequency to avoid loss during transmission along the cabling to the receiver or other component. The signals may also be multiplexed and sent along a single cable 226 to be used by components. While in certain embodiments of the present invention a single cable is used for simplicity and economy, additional cables 228 may also be used to output the downconverted signals. One reason for such additional cabling may be a requirement that the signals being separated by some distances, or similar reason.

After the signals have been downconverted by the downconverter 130, they are then sent to the home or office through cable 136. Thereafter, the signals are sent to a set top box 300, such as the one illustrated in FIG. 3. The signals may be received at an input port 312, where the embodiment illustrated shows the input as a BNC type connector. In alternate embodiments, the set top box 300 may also have a second input port 313, where that port may receive a second signal from the antenna assembly or some other source to be processed by the set top box. The signals are processed by a processor 310, that acts to process and identify the signal being received. Based on the processing, the signals are shunted to adaptors in the set top box. For example, signals may be shunted to adaptor 320 where they may be passed to a coupler 324 or broadcast through an antenna connector 322. Such process may occur where the broadband access signals are received by the set top box 300 and sent to processor 320 for redistribution. Such redistribution could be through wired Ethernet, for example, through coupler 324 or distributed wirelessly, where that wireless distribution may be through BLUETOOTH or some form of distribution through an IEEE 802.11 network, for example. Although an antenna connector 322 is illustrated in FIG. 3, distribution through a wireless network can also be accomplished through an antenna internal to the set top box.

Additionally, signals received by the set top box can also be shunted to an audio/video adaptor 330. Such would be the case for satellite television signals received through the input 312 or 313. For distribution of such signals, as in, for example, video programming, the signal could be output through a back plane of connectors 334, where connections to audio and video equipment can be made. For the sake of compatibility, the set top box should also be able to receive signals through an input 332 that are externally produced audio/video signals.

The set top box 300 can also have at least one PC card slot 341 that allows for PC card adaptors 340 to be inserted to provide additional functionalities. This also allows for adaptors to be quickly switched out to quickly adapt the set top box to provide the processing and redistribution needed.

As discussed above, the set top box illustrated in FIG. 3 can have multiple inputs and outputs, that facilitate the use of multiple data pathways. Additionally, single inputs can also service multiple pathways, where the independent data pathways are only brought together before being input into the set top box. The processor 310 is the entity that evaluates the pathways, measures those pathways against certain criteria and facilitates the use of multiple data pathways to accomplish a single task.

The criteria used to select data pathways vary depending on many factors. The criteria can be based on the type of data being handled in a task, the bandwidths of the individual data pathways, preferences set by a software application or device seeking the task that will use the multiple pathways and past performance and reliability of the data pathways. Thus, if a particular pathway is “bursty”, i.e. producing a high data throughput but variable reliability, then that pathway may be used with another pathway only in situations where the bursty nature does not pose a problem.

The criteria used to select data pathways may also be used such that a given Quality of Service (QoS) is maintained for a given stream of data. Thus, lower QoS streams may be shifted to low bandwidth pathways or halted in order to maintain a higher QoS for a given stream. In addition, in other embodiments, the criteria, used to select pathways, need not be selected automatically, but may presented to a user for selection. In such an embodiment, for example, a user may be offered additional data, such as an alternate viewing angle of something presented in a video presentation, and could either opt for the additional data or eschew the extra data. Additionally, such additional data could be offered for some fee, so that the user may be required to submit to a fee to have access to the extra data.

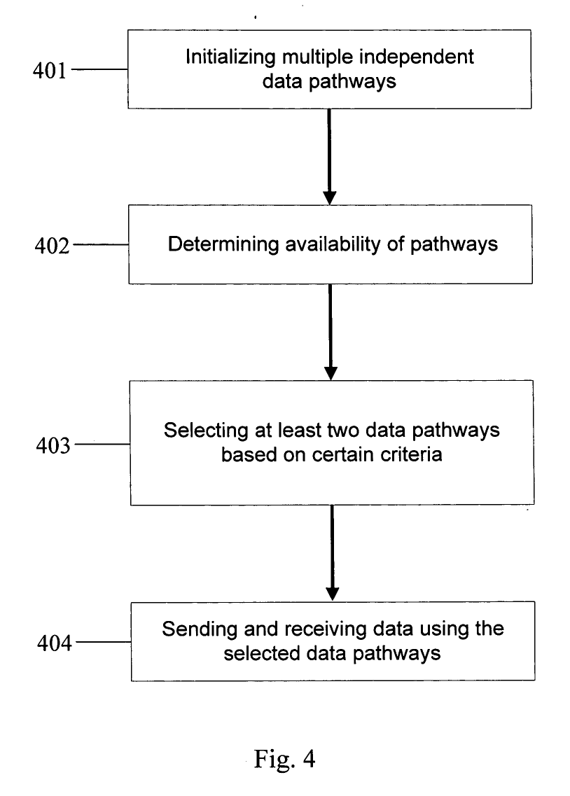

A method of the present invention according to one embodiment is illustrated as a flow chart in FIG. 4. In step 401, the multiple independent data pathways are initialized and their characteristics detailed. Thereafter, in step 402, the availability of the various data pathways us determined, and, in step 403, at least two of those pathways are selected based on certain criteria. Based on the selection, data is sent and received along the selected data pathways to accomplish a given task, in step 404.

Although embodiments of the present invention have been discussed with respect to physical components, the present invention is not so limited. All or part of the functionalities of the present invention may be accomplished solely or partially through software.

It would also be within the scope of the invention to implement the disclosed elements of the invention in discrete electronic components, thereby taking advantage of the functional aspects of the invention. Additionally, the present invention can be implemented totally or partially through software.

Although the invention has been described based upon these preferred embodiments, it would be apparent to those skilled in the art that certain modifications, variations, and alternative constructions would be apparent, while remaining within the spirit and scope of the invention. In order to determine the metes and bounds of the invention, therefore, reference should be made to the appended claims.

1. A method for using multiple independent data pathways to accomplish a task, the method comprising the steps of:
determining availability of multiple independent data pathways, where at least one of the multiple independent data pathways utilizes transmission and receipt of data through an over-the-air antenna;
selecting at least two of the multiple independent data pathways, based on certain criteria; and
sending and receiving data along the selected at least two multiple independent data pathways to accomplish a task.

2. A method according to claim 1, further comprising initializing the multiple independent data pathways and saving information about the multiple independent data pathways and their characteristics in an accessible list.

3. A method according to claim 1, further comprising awaiting a task request by a software application, where the software application supplies the certain criteria.

4. A method for according to claim 1, further comprising awaiting a task request by an electronic device, wherein task requests from the electronic device have predetermined certain criteria.

5. A method according to claim 1, wherein the step of determining availability of multiple independent data pathways comprises determining availability of the multiple independent data pathways, wherein the at least one of the multiple independent data pathways utilizes a satellite antenna.

6. A method according to claim 1, wherein the step of determining availability of multiple independent data pathways comprises determining availability of the multiple independent data pathways wherein the at least one of the multiple independent data pathways utilizes a broadband access antenna.

7. A method according to claim 1, wherein the step of selecting at least two of the data pathways, based on certain criteria comprises selecting the at least two of the multiple independent data pathways based on a type of data to be sent and received.

8. A method according to claim 1, wherein the step of selecting at least two of the multiple independent data pathways, based on certain criteria comprises selecting the at least two of the data pathways based on bandwidths of each of the multiple independent data pathways.

9. A method according to claim 1, wherein the step of sending and receiving data along the selected at least two data pathways to accomplish a task comprises sending and receiving data along the selected at least two data pathways to provide interactive television services in conjunction with satellite television programming.

10. A method according to claim 1, further comprising combining data received from the selected at least two data pathways, such that combined data is treated by an application as having been derived along a single data pathway.

11. A component using multiple independent data pathways to accomplish a task, said component comprising:
determining means for determining availability of multiple independent data pathways, where at least one of the multiple independent data pathways utilizes transmission and receipt of data through an over-the-air antenna;
selecting means for selecting at least two of the multiple independent data pathways, based on certain criteria; and
tasking means for sending and receiving data along the selected at least two multiple independent data pathways to accomplish a task.

12. A component according to claim 11, further comprising initializing means for initializing the multiple independent data pathways and listing means for saving information about the multiple independent data pathways and their characteristics in an accessible list.

13. A component according to claim 11, wherein the component is configured to await a task request by a software application, where the software application supplies the certain criteria.

14. A component for according to claim 11, wherein the component is configured to await a task request by an electronic device, wherein task requests from the electronic device have predetermined certain criteria.

15. A component according to claim 11, wherein the at least one of the data pathways utilizes a satellite antenna.

16. A component according to claim 11, wherein the at least one of the data pathways utilizes a broadband access antenna.

17. A component according to claim 11, wherein the certain criteria are based on a type of data to be sent and received.

18. A component according to claim 11, wherein the certain criteria are based on bandwidths of each of the data pathways.

19. A component according to claim 11, wherein the tasking means is configured to provide interactive television services in conjunction with satellite television programming.

20. A component according to claim 11, further comprising data combining means for combining data received from the selected at least two multiple independent data pathways, such that combined data is treated by an application as having been derived along a single data pathway.

21. A set top box, comprising:
at least one port, configured to send data to and receive data from multiple independent data pathways, where at least one of the multiple independent data pathways utilizes transmission and receipt of signals through an over-the-air antenna; and
a processing module, configured to determine availability the data paths, select at least two of the multiple independent data pathways, based on certain criteria and monitor a task utilizing the selected at least two multiple independent data pathways.

22. A set top box according to claim 21, wherein the processing means is further configured to initialize the multiple independent data pathways and save information about the multiple independent data pathways and their characteristics in an accessible list.

23. A set top box according to claim 21, wherein the set top box is configured to await a task request by a software application, where the software application supplies the certain criteria.

24. A set top box for according to claim 21, wherein the set top box is configured to await a task request by an electronic device, wherein task requests from the electronic device have predetermined certain criteria.

25. A set top box according to claim 21, wherein the at least one of the data pathways utilizes a satellite antenna.

26. A set top box according to claim 21, wherein the at least one of the data pathways utilizes a broadband access antenna.

27. A set top box according to claim 21, wherein the certain criteria are based on a type of data to be sent and received.

28. A set top box according to claim 21, wherein the certain criteria are based on bandwidths of each of the multiple independent data pathways.

29. A set top box according to claim 21, wherein the processing module is configured to provide interactive television services in conjunction with satellite television programming.

30. A set top box according to claim 21, the processing means is further configured to combine data received from the selected at least two data pathways, such that combined data is treated by an application as having been derived along a single data pathway.
